(19) United States
(12) Patent Application Publication
(10) Pub. No.: US 2017/0325922 A1
(43) Pub. Date: Nov. 16, 2017

(54) WIPING DEVICE FOR DENTAL TOOLS

(71) Applicants: Benjamin M. Kandel, Centreville, VA (US); Jacob A. Kandel, Centreville, VA (US)

(72) Inventors: Benjamin M. Kandel, Centreville, VA (US); Jacob A. Kandel, Centreville, VA (US)

(21) Appl. No.: 15/489,136

(22) Filed: Apr. 17, 2017

Related U.S. Application Data
(60) Provisional application No. 62/324,263, filed on Apr. 18, 2016.

(51) Int. Cl. A61C 19/00

(52) U.S. Cl. CPC A61C 19/002; A61C 19/006

(57) ABSTRACT

A wiping device for dental tools includes an adjustable wristband configured to be worn around a wrist of a user, and a scaler platform presenting a generally widened expanse, mounted to the wristband. The scaler platform includes a surface suitably configured to receive a wiping material in a position accessible by the user. Advantageously, the scaler platform is positioned forward of the wristband, so as to overlay the back of a hand of the user.

### CROSS REFERENCE TO RELATED APPLICATIONS

This application claims the benefit of U.S. Provisional Application No. 62/324,263 filed Apr. 18, 2016 entitled WRIST-MOUNTED WIPING DEVICE FOR DENTAL TOOLS.

### BACKGROUND OF THE INVENTION

The present invention relates to dental tools, and particularly to a wiping device for dental tools which is advantageously wrist-mounted.

Professional dental cleaning procedures generally require the use of various dental tools, such as dental scalers and picks, as well as the use of both hands to properly position a dental tool in a patient's mouth. During a single cleaning procedure a dental professional is required to clean or wipe a particular tool numerous times. Such repeated wiping of a cleaning tool during a procedure can become arduous, especially when both hands are needed to clean the tool.

In light of the above, there is a need for a more convenient means of performing dental hygiene procedures with improved ergonomics, efficiency, and sterility. Thus, a wrist-mounted wiping device for dental tools solving the aforementioned problems is desired.

### SUMMARY OF THE INVENTION

In broad terms, a wrist-mounted wiping device for dental tools according to an embodiment of the invention comprises an adjustable wristband configured to be worn around a wrist of a user, and a scaler platform, advantageously of widened expanse, mounted to the wristband and including a surface suitably configured to receive a wiping material in a position accessible by the user. The positioning of the scaler platform relative to the wristband is not deemed critical to practice of the invention. However, an advantageous embodiment positions the scaler platform forward of the wristband, so as to overlay the back of a hand of the user.

In accordance with an advantageous embodiment of the invention, structure for mounting the scaler platform to the wristband comprises a detachable connector, provided conveniently in the form of a flexible member coupled to the wristband at one end thereof, and to the scaler platform at an opposed end thereof. For use, the wristband is secured to the wrist of a user, and the widened expanse comprising the scaler platform advantageously lies on, or generally overlays, the back of the user's hand during use. Alternatively, the scaler platform could be mounted to the wristband in a manner which positions the scaler platform to overlay the back of the forearm, the wrist or the hand (or a combination thereof) of the user, in a position which can be readily accessed by the other hand of the user in which the dental tool requiring cleaning is held.

The scaler platform provides a support surface for suitable wiping material for example, a gauze pad, received and held thereto, and which facilitates wiping of dental tools during dental procedures. The wiping material is advantageously held to the back (i.e., outward facing) surface of the scaler platform by suitable structure which operates to restrict unwanted movement of the wiping material during a wiping operation. To this end, a mechanism is optionally provided, for example, conveniently in the form of at least one clip mounted to opposite side edges of the scaler platform, operable to selectively clamp a wiping material, and to optionally also hold a cleaning product container.

These and other features of the present invention will become readily apparent upon further review of the following specification and drawings, in which similar reference characters denote corresponding features consistently throughout the attached drawings.

### BRIEF DESCRIPTION OF THE DRAWINGS

FIG. 1 is an environmental, perspective view of a wrist-mounted wiping device for dental tools according to an embodiment of the present invention;

FIG. 2 is a perspective view of the embodiment of the wrist-mounted wiping device for dental tools shown in FIG. 1;

FIG. 3 is a top plan view of the embodiment of the wrist-mounted wiping device for dental tools shown in FIGS. 1 and 2;

FIG. 4 is an exploded view of the embodiment of the wrist-mounted wiping device for dental tools shown in FIG. 1-3;

FIG. 5 is a perspective view of a scaler platform for the wrist-mounted wiping device for dental tools according to a second embodiment of the present invention;

FIG. 6 is a perspective view of a connector member for the wrist-mounted wiping device for dental tools according to an alternative embodiment of the present invention;

FIG. 7A is a perspective view of a scaler platform for the wrist-mounted wiping device for dental tools according to a third embodiment of the present invention;

FIG. 7B is a perspective view of a scaler platform for the wrist-mounted wiping device for dental tools according to a fourth embodiment of the present invention;

FIG. 8 is an environmental, perspective view of a wrist-mounted wiping device for dental tools according to an alternative embodiment of the present invention; and

FIG. 9 is an environmental, perspective view of a wrist-mounted wiping device for dental tools according to another alternative embodiment of the present invention.

### DETAILED DESCRIPTION OF THE PREFERRED EMBODIMENTS

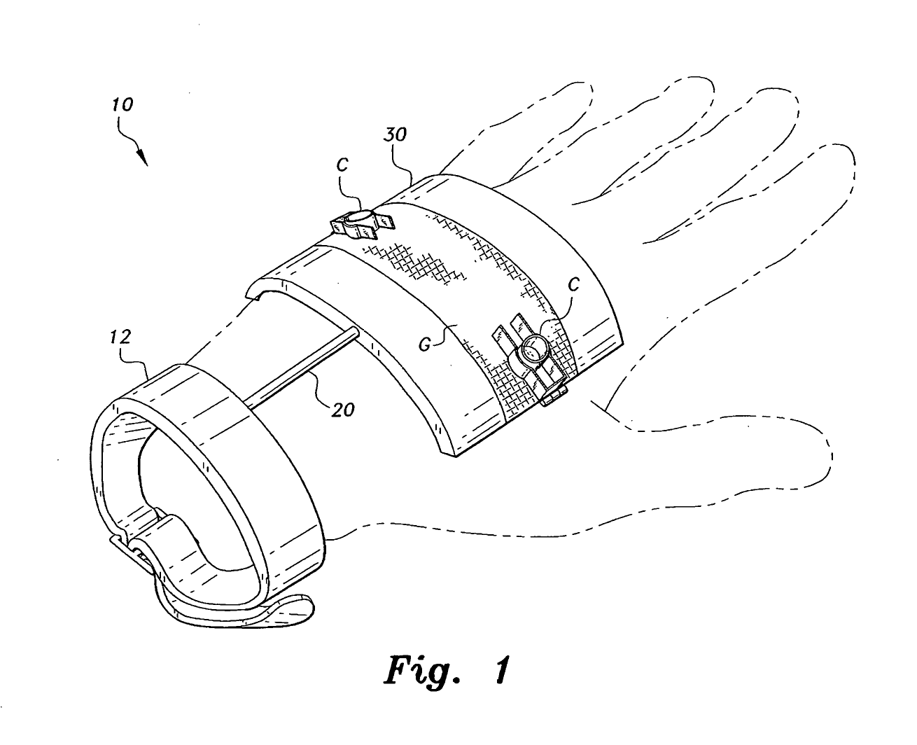

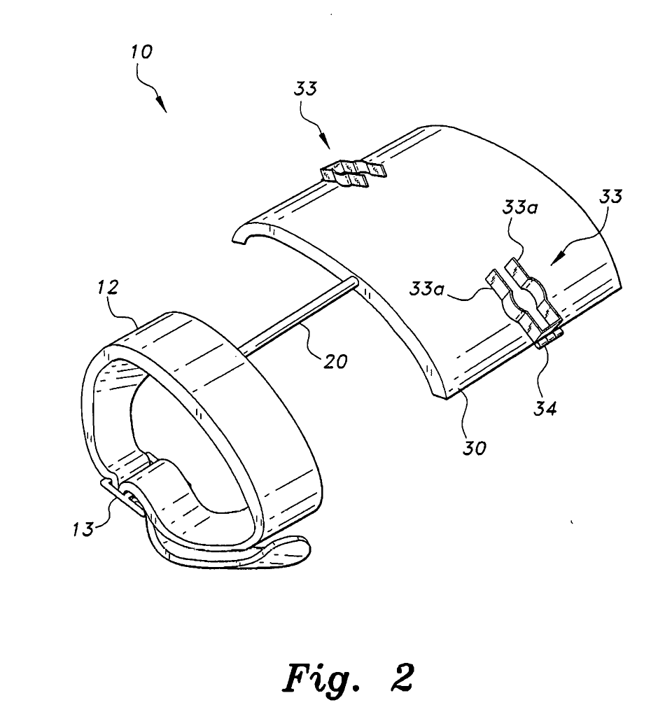

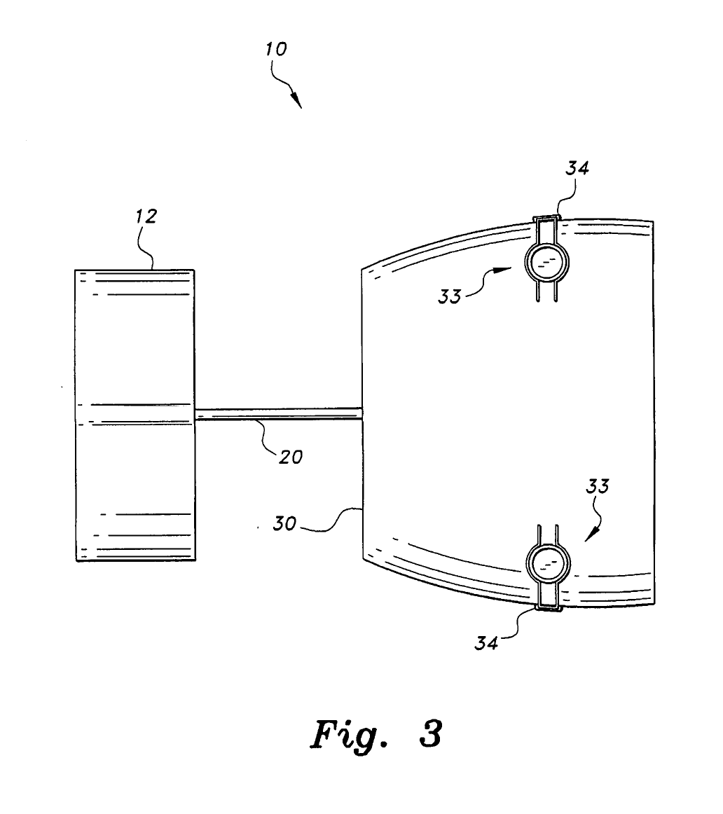

Referring now to the figures, a first embodiment of a wrist-mounted wiping device for dental tools according to the invention is depicted in FIGS. 1-4, generally referred to by the reference number 10. Wrist-mounted wiping device for dental tools 10 includes a wristband 12, a scaler platform 30, and a connector member 20. The connector member 20, as shown, is optionally detachably mounted to the wristband 12 and the scaler platform 30.

The wrist-mounted wiping device for dental tools 10 provides a convenient wiping surface for dental tools during a dental procedure by placing, within easy reach, a wiping surface which can easily be accessed the other hand of the user in which a dental tool is held.

The wristband 12, while depicted as a generally elongate strip of material configured to be adjustably worn around the wrist of the user, can take any suitable form generally employed for conventional wristbands, for example as are used for wristwatches and other wrist-mounted articles. In the depicted example, the wristband 12 is conveniently provided with a buckle 13 to enable adjustable fastening of the wristband 12. The buckle 13 may be any type of buckle such as a tongue buckle, friction buckle, or a side-release buckle. The wristband 12 size can be adjusted to conform to the size of a user's wrist. The wristband 12 and other components of the wrist-mounted wiping device for dental tools 10 are advantageously comprised of durable, medical-grade plastic, metal, and/or composites that can withstand rigorous cleaning or are autoclavable. For example, the wristband 12 and other components described herein can be made from polypropylene, polymethylpentene, polycarbonate, or polytetrafluoroethytene (PTFE) resin.

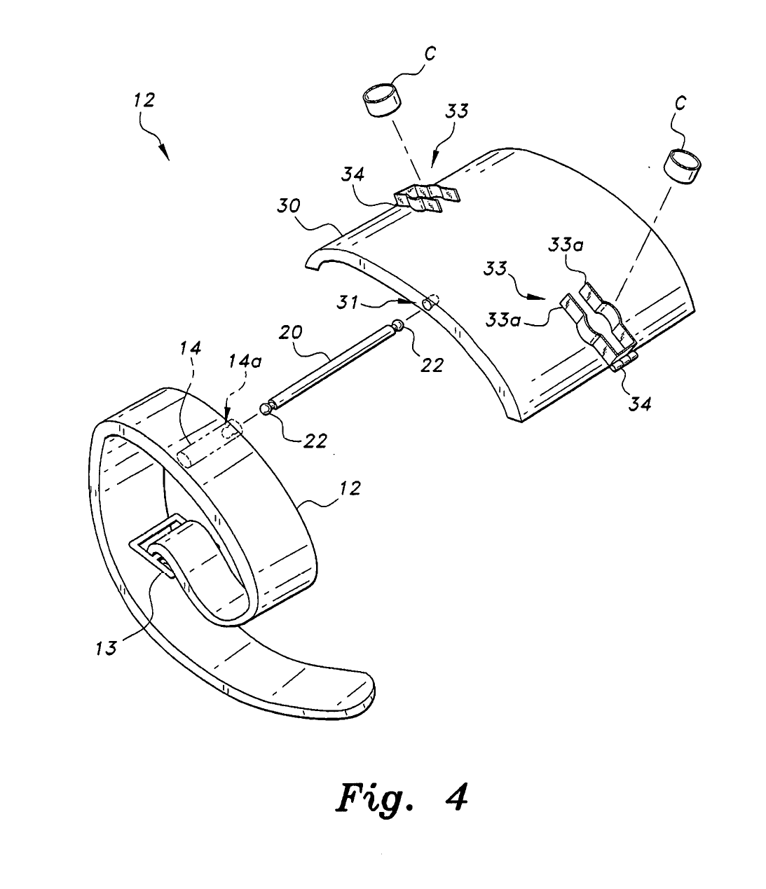

The connector member 20 connects the wristband 12 to the scaler platform 30. The connector member 20 can be detachably connected to the wristband 12 and the scaler platform 30 in any suitable manner. For example, as best shown in FIG. 4, the connector member 20 may be a generally elongate, cylindrical, post with a joint or plug 22 extending from each end. One plug 22 couples to the wristband 12, e.g., a socket cylinder 14 within the wristband 12, while the opposite plug 22 couples to a corresponding socket 31 within the scaler platform 30. When assembled, the connector member 20 spans a relatively short distance from the user's wrist to the back of the user's hand. The connector member 20 is advantageously constructed from a flexible material to accommodate movements of the user's hand above which the scaler platform 30 overlays a back of the hand in close proximity.

Once the wrist-mounted wiping device for dental tools 10 is properly positioned, as depicted in FIG. 1, the scaler platform 30 advantageously lies on the back of the user's hand, or is spaced apart therefrom, for example, by a minimal distance. Gauze G or any other suitable cleaning pad or material is received and retained on the scaler platform 30 by suitable mounting structure, for example in the depicted version, conveniently by clips 33. As described in detail below, clips 33 can also be used to hold small containers C of paste or other cleaning products on the scaler platform 30. The scaler platform 30 is advantageously comprised of a curved plate, configured to ergonomically conform to the natural curvature of the back of the user's hand. The plate comprising the scaler platform 30 can take any suitable shape, for example, it may be generally trapezoidal, square or rectangular in shape.

Each clip 33 is advantageously mounted to the scaler platform 30 at opposite sides thereof. In the depicted example, each clip 33 may optionally additionally include a pair of flexible tongs, jaws, or sidewalls 33a configured to clamp a curved object or container C therebetween. Each clip 33 in advantageously biased in a clamped position in which the gauze G is securely held to the scaler platform 30, conveniently by the provision of a biased hinge or pivot 34 at opposing side edges of the scaler platform 30. The biased hinge 34 permits the clip 33 to pivot with respect to the top of the scaler platform 30 to enable securing of an edge or end of a strip of gauze G to the scaler platform 30. Thus, each clip 33 performs securing functions in two different directions, i.e., clipping an object between the tongs 33a (a first direction), and clipping an object, i.e., a suitable wiping material, for example gauze G, onto the scaler platform 30 (a second direction perpendicular to the first direction).

In use, the user secures opposite ends of a strip of gauze G to extend between the clips 33. The gauze G can be used to wipe off plaque, tartar or calculus from a dental tool (not shown) during a dental cleaning procedure. To maintain or follow typical sterile protocols, the ends of the gauze G will preferably not extend past the side edge of the scaler platform 30. If the procedure requires paste or other cleaning products, etc., the user may secure a container C filled with such product between the tongs 33a of one or both of the clips 33. When all the desired objects have been secured or mounted to the scaler platform 30, the wristband 12 of the wrist-mounted wiping device for dental tools 10 can be secured around a user's wrist, and the scaler platform 30 positioned on the back of the user's hand, as shown in FIG. 1. The wrist-mounted wiping device for dental tools 10 provides a convenient cleaning tool that can be accessed using just one of the user's hands during a particular procedure. The wrist-mounted wiping device for dental tools 10 reduces extraneous movements that may potentially cause unintentional dropping of instruments or contamination.

Advantageously, the wrist-mounted wiping device for dental tools 10 is worn on the non-dominant hand of the user, such that the dental tool is held in the other dominant hand.

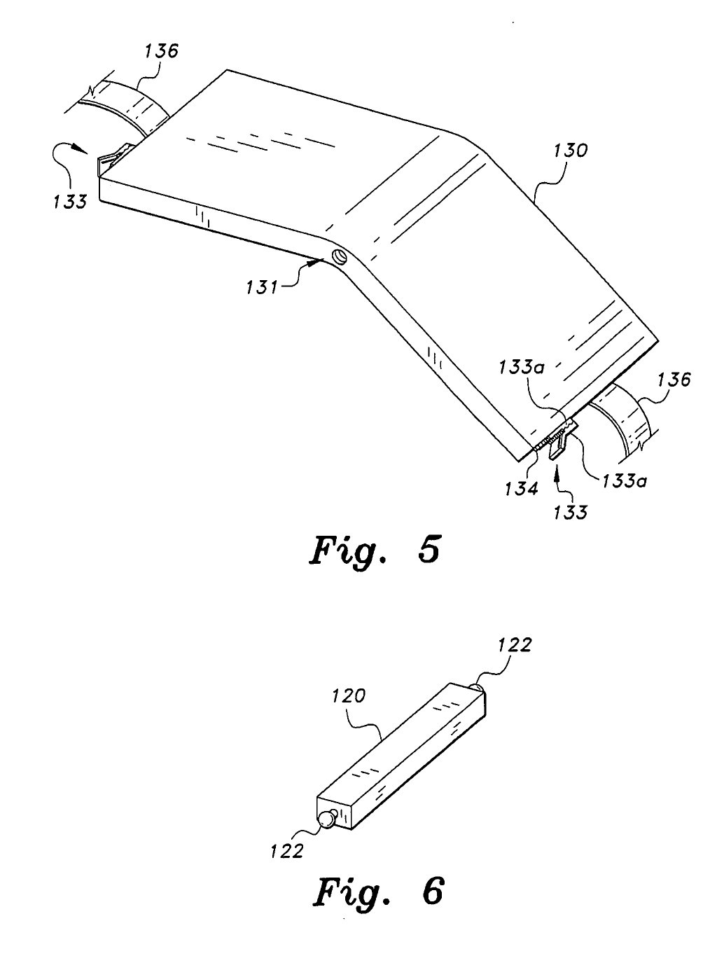

Another embodiment of a scaler platform 130 is depicted in FIG. 5, in which the scaler platform 130 may be angled, rather than curved. Similar to the embodiment described above with reference to FIGS. 1-4, the scaler platform 130 is provided with a socket 131 to receive one of the plugs 22 of the connector member 20 for connection to a wrist band (not shown in FIG. 5), in a manner analogous with the first embodiment. Therefore further description or depiction with regard to the present embodiment is deemed unnecessary, as redundant.

As shown in FIG. 5, clips 133 of the scaler platform 130, which function to secure gauze G, etc., to the scaler platform 130, and optionally also a container holding cement, etc., are conveniently provided in the form of alligator clips having biased jaws 133a for grasping and securing objects therebetween. An end of each of the clips is also mounted to a side edge of the scaler platform 130 by a biased hinge 134 to permit selectively clamping a cleaning material, e.g., gauze G, onto the side edge of the scaler platform 130. To further (or alternatively) secure the wrist-mounted wiping device for dental tools 10, the scaler platform 130 (or the scaler platform 30 of FIGS. 1-4) may optionally include a hand strap 136 that can be worn around the palm of the hand.

Another embodiment of a connector member 120 is shown in FIG. 6. Similar to connector member 20, the connector member 120 can be used to connect the wristband 12 with the scaler platform 30 or the scaler platform 130. The connector member 120, however, as depicted, can include a plurality of flat surfaces, and a plug 122 extending from opposing ends of the member 120. The connector member 120 advantageously is flexible (and in a particularly advantageous form, also exhibits resiliency), and bends easily in response to the user's hand and/or wrist movements while providing secure and reliable support between the wristband 12 and the scaler platform 30, 130.

The cross sectional shape of the connector member 120 may be rectangular as shown, or any other suitable shape.

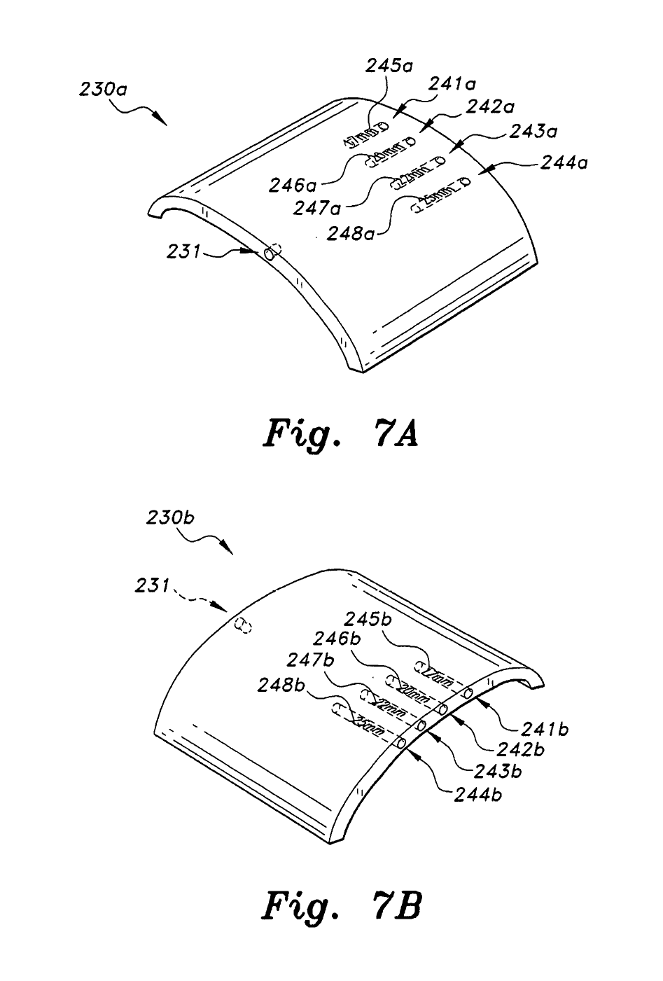

Further embodiments of a scaler platform are shown in FIGS. 7A and 7B. For simplified depiction, all other elements present, for example, as shown in FIG. 1, are not depicted in these figures. In these embodiments, the scaler platforms 230a, 230b additionally include features for assisting dental professionals in performing root canal procedures, cleaning, and the like. Both are provided with a respective socket 231 for selective coupling with a connector plug.

As shown in FIG. 7A, the scaler platform 230a is provided with a plurality of elongate gauge slots 241a, 242a, 243a, 244a, each extending from the top surface into the thickness of the scaler platform at an angle. Each gauge slot 241a, 242a, 243a, 244a extends a different length into the scaler platform 230a, and each gauge slot 241a, 242a, 243a, 244a corresponds to a standard length or dimension of a dental reamer or file.

A root canal procedure may require one or more different sized dental reamers depending on the patient's physiology. It is imperative that correct sized reamers are used, and the dental professional may, at times, find it difficult to pick the correct one due to the relatively small differences in length amongst the variety of reamers at his/her disposal. The gauge slots 241a, 242a, 243a, 244a serve as check guides for the user as a means of checking the size of the dental reamer. Each gauge slot 241a, 242a, 243a, 244a also optionally includes a corresponding indicia 245a, 246a, 247a, 248a near its entrance hole, the indicia 245a, 246a, 247a, 248a designating the specific standard size for a reamer, e.g. “17 mm,” “20 mm,” “22 mm,” “25 mm,” etc. Other types of indicia, such as scales, color codes, symbols, combinations, and the like, may also be used additionally or alternatively.

In use, the user inserts a desired reamer into a select gauge slot, e.g. 17 mm guide 241a, to determine its length. If the reamer is too long, a portion of the working section of the reamer will extend out of the selected gauge slot 241a. This extra extension visually indicates the selected gauge slot 241a is of incorrect size. If the reamer is too short, the user inserts the reamer into the next shortest gauge slot 241a, 242a, 243a, or 244a to verify size. For example, inserting a 17 mm reamer into a 22 mm gauge slot 243a will show that the 17 mm fits. To verify the correct size, however, the user inserts the 17 mm reamer into the 20 mm gauge slot 242a and so on until the reamer seats into the shortest gauge slot 241a without any working portion thereof extending out.

Each gauge slot 241a, 242a, 243a, 244a also serves as a holder for the particular sized reamer.

Some dental procedures may require the use of more than one sized reamer. To maximize efficiency and convenience, the gauge slots 241a, 242a, 243a, or 244a allows the dental professional to hold the required reamers in their corresponding sized gauge slot 241a, 242a, 243a, 244a throughout the procedure.

In the embodiment shown in FIG. 7B, the scaler platform 230b is a variation of the scaler platform 230a. The scaler platform 230b includes a plurality of elongate gauge slots 241b, 242b, 243b, 244b extending from one end of the scaler platform 230b, advantageously the front end facing the user's knuckles when worn, into the thickness thereof. As with the scaler platform 230a, the extension of each gauge slot 241b, 242b, 243b, 244b into the scaler platform 230b is different from each other, with each corresponding to the standard lengths or dimensions of a dental reamer or file. Each gauge slot extension is horizontally straight rather than at an angle as in the scaler platform 230a. This arrangement may simplify manufacturing due to the placement of the gauge slots 241b, 242b, 243b, 244b. The scaler platform 230b is also provided with a plurality of indicia 245b, 246b, 247b, 248b with each placed near the corresponding gauge slot 241b, 242b, 243b, 244b being referenced thereby. The indicia 245b, 246b, 247b, 248b, as well as the indicia 245a, 246a, 247a, 248a, are advantageously placed where they can be easily and clearly seen by the user, and not obscured by gauze G when held to the scaler platforms 230a, 230b.

While the previously described embodiments place the scaler platform 10, 130, 230a, 230b forward of the wristband 12 and spaced apart therefrom by connector member 20, 120, other relative placements are contemplated within the scope of the invention.

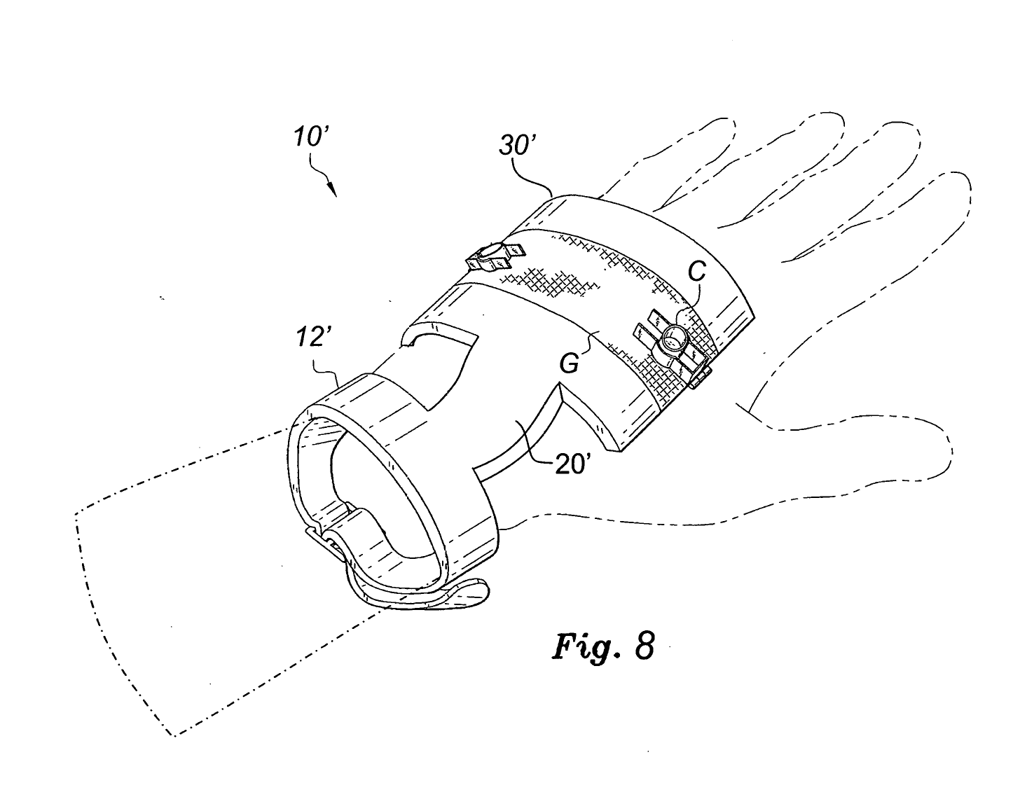

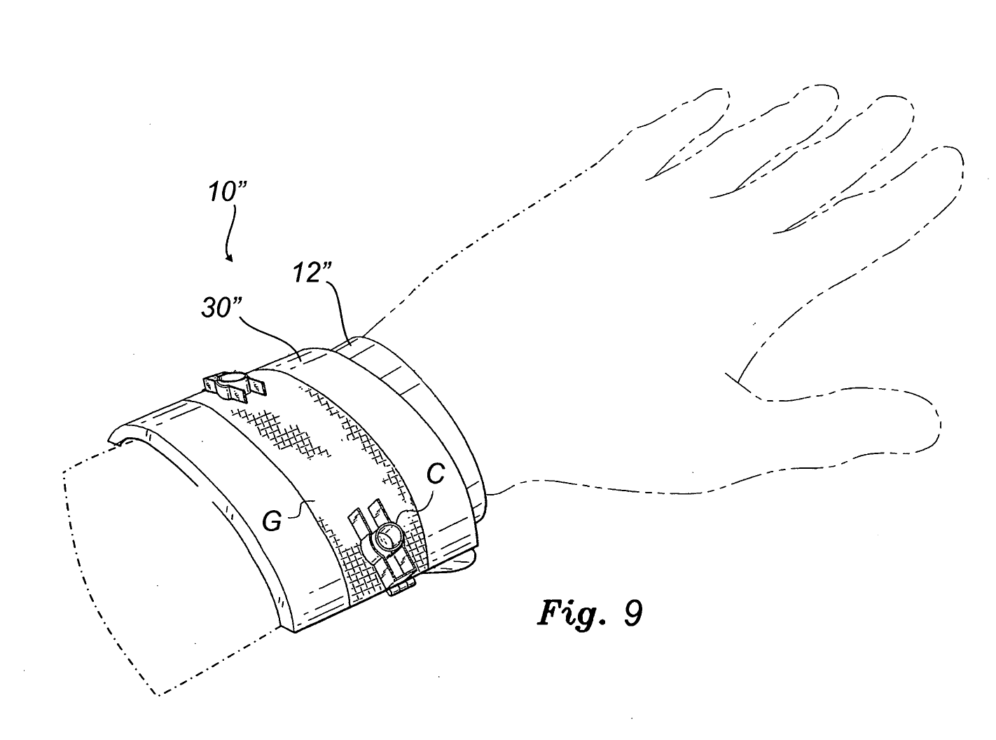

Turning now to FIGS. 8 and 9, alternative embodiments of the invention are depicted, serving to illustrate the breadth of the contemplated scope of the invention.

A wrist-mounted wiping device for dental tools according to an alternative embodiment of the invention is depicted in FIG. 8, generally referred to by the reference number 10′. Wrist-mounted wiping device for dental tools 10′ in the depicted embodiment is formed as a unitary body which includes a wristband portion 12′, a scaler platform portion 30′ and a connector portion 20′. The material used for the wrist-mounted wiping device 10′ is relatively inflexible or moderately rigid, with the exception, perhaps, of the adjustable portion of the wristband portion 12′ (i.e., regions extending adjacent to the buckle or other adjustable fastener), which portion can either be fastened to a remainder of the wrist-mounted wiping device for dental tools 10′, or integrally incorporated therewith, for example, during a suitable molding process, for example, by overmolding a flexible material to the molded rigid material, by known methods.

Since the connector portion 20′ of the present embodiment is at least moderately rigid, unlike the connector member 20 which is advantageously constructed from a flexible material to accommodate movements of the user's hand above which the scaler platform 30 overlays a back of the hand in close proximity, the connector portion 20′ is configured so as to space the scaler platform portion 30′ sufficiently above the back of the user's hand, as shown in FIG. 8, so as not to impede necessary hand movement.

FIG. 9 depicts another alternative embodiment of a wrist-mounted wiping device for dental tools according to the invention, generally referred to by the reference number 10″, which comprises a scaler platform 30″ directly mounted to a wristband 12″, such that provision of a connector member is unnecessary. Unlike the previous examples, in which the scaler platform (and the scaler platform portion) is positioned forward of the wristband, in this embodiment, the scaler platform 30″ overlays at least a portion of the wristband 12″ and at least a portion of the scaler platform 30″ extends rearward of the wristband 12″ so as to overlay the forearm of the user adjacent to the wrist. If so desired, a connector could optionally be provided to space the scaler platform 30″ rearward from the wristband 12″.

It is to be understood that the wrist-mounted wiping device for dental tools 10 encompasses a variety of alternatives. For example, while the preferred materials for constructing the wrist-mounted wiping device for dental tools 10 are preferably medical-grade, the wrist-mounted wiping device for dental tools 10 may also be constructed from other materials such as non-medical grade plastics, metals, and/or composites for disposable, single use.

Various other types of clips, such as various forms of spring clips and the like, may be used.

Moreover, one or more clips may be mounted on or near the side edges of the scaler platform 30, 130, 230a, 230b. Furthermore, the wrist-mounted wiping device for dental tools 10 may be provided with more than one connector member 20, 120 to further secure connection between the wristband 12 and the scaler platform 30, 130, 230a, 230b. The connector member 20, 120 may also be a unitary component, integral with the wristband 12 and the scaler platform 30, 130, 230a, or 230b.

Also, while clips have been described to accomplish attachment of the wiping material to the scaler platform, the wiping material can instead simply be secured by use of adhesive carried on either the working top surface of the scaler platform or a back of the wiping material.

Having described preferred embodiments of the invention with reference to the accompanying drawings, it is to be understood that the invention is not limited to those precise embodiments, and that various changes and modifications may be effected therein by one skilled in the art without departing from the scope or spirit of the invention.

What is claimed is:

1. A device for facilitating cleaning of dental tools, comprising:
a scaler platform presenting a top surface of expanded dimension to which a wiping material is receivable, said scaler being adapted to overlay a back of a hand of a user; and
a wristband adapted for reception about a wrist of the user, said scaler platform being mounted to said wristband.

2. A device according to claim 1, wherein said expanded dimension of said scaler platform includes a curvature configured to ergonomically conform to a natural curvature of the back of the hand of the user.

3. A device according to claim 1, further comprising at least a pair of clips being mounted to said scaler, said clips being operable to fasten the wiping material to said top surface.

4. A device according to claim 3, wherein said at least the pair of clips being disposed on opposing sides of the scaler platform.

5. A device according to claim 1, further comprising a connector which is configured to mountably couple said scaler platform to said wristband.

6. A device according to claim 5, wherein said connector comprises a flexibly resilient elongated member.

7. A device according to claim 5, wherein said connecter and said scaler platform are provided as a unitary construction.

8. A device according to claim 1, wherein said wristband includes ends fastenable to one another to allow for size adjustment.

9. A method of facilitating cleaning of a dental tool, comprising:
adapting a scaler platform to overlay a back of a forearm, a wrist or a hand of a user; said scaler platform presenting a top surface opposite to another surface facing the hand of the user;
fastening a wiping material to said top surface; and
cleaning the dental tool being held in another hand of the user by wiping a portion of the tool on said wiping material.

10. A method according claim 9, wherein said another hand of the user is a dominant hand.

11. A method according to claim 9, wherein said scaler platform includes a curvature configured to ergonomically conform to a natural curvature of the back of the hand of the user.

12. A method according to claim 9, further comprising:
mounting at least a pair of clips being to said scaler, said clips being operable to fasten the wiping material to said top surface.

13. A device for facilitating cleaning of dental tools, comprising:
a scaler platform presenting a top surface of expanded dimension to which a wiping material is receivable, said scaler being adapted to overlay a back of at least one of a hand, a wrist or a forearm of a user; and
at least one band adapted for reception about at least one of a wrist or a palm of the user, said scaler platform being mounted to said band.

14. A device according to claim 13, wherein said at least one band includes a wristband and a hand strap.
